(19) United States
(12) Patent Application Publication
(10) Pub. No.: US 2007/0006698 A1
(43) Pub. Date: Jan. 11, 2007

(54) Device for trimming brochures

(76) Inventor: Heinz A. Kurtz, Altusried (DE)

Correspondence Address: FRIEDRICH KUEFFNER, 317 MADISON AVENUE, SUITE 910, NEW YORK, NY, 10017, US

(21) Appl. No.: 11/522,130

(22) Filed: Sep. 15, 2006

Related U.S. Application Data
(63) Continuation of application No. 10/817,676, filed on Apr. 3, 2004, now abandoned.
(62) Division of application No. 09/573,311, filed on May 18, 2000, now abandoned.

(30) Foreign Application Priority Data
May 20, 1999 (EP) 99109922.7

(51) Int. Cl. B26D 7/06

(52) U.S. Cl. 83/13; 83/100

(57) ABSTRACT

A trimming device having a trimming knife for trimming a brochure along a trimming plane at a front end of the brochure has one or more suction elements in the area of the brochure to be trimmed. The brochure has a cover and an inner book cased in the cover with flaps of the cover being flush with or projecting past the inner book. The suction element is configured to bulge a flap and retract a flap away from the trimming plane.

### CROSS-REFERENCE TO RELATED APPLICATIONS

This application is a divisional application of U.S. application Ser. No. 09/573,311.

### BACKGROUND OF THE INVENTION

1. Field of the Invention

The invention relates to a device, especially a standard three knife trimmer, for trimming brochures along a trimming plane at the front end of the brochure with projecting or flush flaps of a cover that cases an inner book.

2. Description of the Related Art

Covers of brochures are often provided with folded-in flaps which correspond only to a portion of the width of the inner book or which project completely to the edge of the inner book.

The edges of these covers are either recessed, flush with, or project past the inner book. While the recessed folded-in flaps can be trimmed like regular brochures at the head, foot, and front end after the inner book has been cased therein, such a trimming action is not possible in the case of flush or projecting flaps. The front end trimming must be performed after inner book binding in the adhesive binding device, and subsequently the inner book is cased in the cover by carrying out a further pass through the adhesive binding device with subsequent trimming of the head and foot. Up to now, this has resulted in additional process steps and thus in additional costs.

But even in the case of covers which are to be flush or only minimally retracted, there is always the risk, as a result of normal production fluctuations, that the folded-in flaps are completely or partially cut.

Also, in the case of brochures which are provided with a protective cover glued to the spine or to the fourth cover page or loosely placed about the brochure, the same problem results. For such brochure types, referred to as “English brochures”, the European patent document 0 754 566 discloses a method and a device according to which in a special cutting apparatus, in which the inner book is trimmed at the front end in a flat resting position, the top and bottom cover portions are folded away and, subsequently, the inner book is placed onto a cutting support, pressed from above against the support, and then trimmed.

The top and bottom cover portions, by being folded away, are in a position far removed from the front end trimming knife. The cutting apparatus is very complex since it allows opening of envelopes, transport, alignment, has pressing and cutting devices, and provides possibilities for closing flaps.

Since usually only a certain percentage of brochures is produced in this manner, the complex apparatus is used only part of the time and is thus not economical.

### SUMMARY OF THE INVENTION

It is an object of the present invention to perform, especially with a conventional three knife trimmer, trimming at the front end after casing of the brochure in a cover with projecting or flush flaps such that, despite conventionally unavoidable production fluctuations, the flaps at the front end of the brochure are not cut or damaged.

In accordance with the present invention, this is achieved in that the trimming device has at least one suction element in the area of the brochure to be trimmed for bulging and retracting the flap edge away from the trimming plane.

Accordingly, the object is solved according to the invention for a device such that the device has at least one suction element in the area of the brochure to be trimmed for holding and retracting the flap edge out of the trimming plane. During the trimming process the cover is moved out of the trimming area for a short period of time by the device according to the invention so that a risk-free trimming of the inner book can take place. Depending on the size of the trimmed-off portion, the cover can either be slightly projecting, flush or retracted relative to the inner book after gliding back into the initial position. In particular, a standard three knife trimmer can be retrofitted with such a suction element. The basic principle is that a standard trimmer can be used as a carrier of the inventive device so that the standard trimmer can be employed for other purposes when not used for trimming flap brochures. The additional pass through the adhesive binding device is avoided, rejects resulting from cutting of the flap edges are eliminated, and an increased economic efficiency for manufacturing the aforementioned brochures is achieved.

The suction element can be integrated into a conventional three knife trimmer which, in addition to the front end cut, also performs at the same time the head and foot cuts. This can be very easily realized with a three knife trimmer in which the head/foot trimming and the front end trimming are performed at two separate stations; this is a so-called three knife flow trimmer. In this context it does not matter whether the front end trimming is performed first or is carried out subsequent to the foot/head trimming action. The machine expenditure for eliminating the second pass in the production of the brochures with folded-in, projecting flaps is then limited to the flap retraction device in the form of the suction element according to the invention.

In one embodiment of the invention it is suggested that the suction element has correlated therewith at least one holding-down device. After bulging and retraction of the flap edge from the trimming plane, this holding-down device prevents accidental return of the flap edge. The holding-down device presses the flap securely against the inner book during the trimming action.

Advantageously, several suction elements are provided, preferably arranged linearly along a straight line extending parallel to the spine of the inner book. With this arrangement, the device can be adjusted to brochures of different lengths by simply switching on and switching off individual suction elements. This adjustment would not be as easily possible for a bar-shaped design of the suction elements because in the case of smaller sized brochures secondary air could enter the suction device at its sides so that the suction force would be disadvantageously reduced.

When suction elements are provided on the top side and bottom side of the inner book for the purpose of bulging and retracting a flap, both flaps, i.e., the top as well as the bottom flap of the cover, can be retracted so that both may project past the front end of the inner book after return of the flaps.

The stroke by which the flap is bulged and retracted can be adjusted advantageously independent of the vacuum of the suction element when a drive is provided, preferably a piston-cylinder-unit, in order to move the suction elements from a suction position into a holding position and back, wherein this bidirectional movement direction is preferably slanted relative to a normal onto the flap.

The respectively desired projection of the flap past the front end of the inner book can be expediently adjusted when adjusting elements for adjusting the suction position and/or the holding position of the suction element are provided.

The feature that the suction element has a suction cup which is moveably supported in the bidirectional movement direction contributes to a gentle treatment of the cover flap during bulging and retraction. With this measure, the suction element can follow the natural movement of the flap without exerting forces onto the flap surface.

A further embodiment, wherein the suction cup is provided with a support structure for the flap, serves the same purpose. The forces applied by the vacuum onto the flap can thus be dissipated across a large surface area within the suction cup without leaving marks on the flap.

When the suction cup is moveably supported in at least one direction transverse to the bidirectional movement direction, it is also possible to compensate minimal lateral movements without leaving marks on the flap.

Since the support structure has a concave enveloping surface, which is preferably a part of a cylinder surface, the suction cup conforms to the contour of the cover flap without leaving lateral impressions on the flap.

The measure that the suction position and/or holding position of each suction element can be adjusted individually and independently of the other suction cups also serves to provide a gentle treatment of the flap.

When the suction element has a channel which communicates with a vacuum source that can be switched on or off, the flap can be automatically returned into its initial position by switching off the vacuum without requiring additional mechanical deflecting elements.

The forces acting on the flap can be adjusted especially finely by providing between the suction element and the vacuum source a throttle location in the channel which is preferably adjustable and/or closeable. By closing the throttle location, the suction elements can be adjusted to the book dimensions or the dimensions of the brochures. The suction elements positioned past the outer edges of the brochure are switched off by closing the throttle location.

Preferably, the trimming device has a working cycle and comprises means for synchronizing the movement of the suction element with the working cycle.

In a preferred embodiment, a trimming table is provided which has a ledge facing the knife in the trimming plane, wherein the bottom flap can be retracted behind the ledge.

Preferably, several suction elements are arranged on a suction bar.

It is a further object of the present invention to provide a method that is more productive than known manufacturing methods for trimming the front end of brochures along a trimming plane, wherein the brochures have projecting or flush flaps of a cover in which an inner book is cased.

In accordance with the present invention, this is achieved in that, before trimming, the flap is retracted away from the trimming plane by producing a bulge of the flap.

With the inventive method, during the cutting process the cover is moved for a short period of time out of the trimming area to such an extent that a risk-free trimming of the inner book can take place. Depending on the size of the trimmed-off portion, the cover can either be slightly retracted, flush or projecting after returning into the initial position. The generation of a bulge and the retraction of the flap from the trimming plane can be performed advantageously on a standard three knife trimmer. This avoids the additional pass through the adhesive binding device; rejects resulting from cutting of the forward edge of the flap no longer occur; and the economical efficiency of the manufacture of brochures is increased.

In one embodiment of the method it is suggested that the bulges of the flap are generated by using vacuum. The use of vacuum for producing the bulge has the advantage that the integrity of the flap is substantially protected and that there is no risk of damage by mechanical manipulation devices.

As soon as a sufficient bulge has been produced, a holding-down device presses the flap onto the inner book at the front end of the brochure where the brochure opens until the trimming action at the front end is completed.

The effect of the vacuum is required only for the immediate process of generating the bulge. As soon as the flap is pressed against the inner book, vacuum can be canceled.

For further increasing the economic efficiency, the trimming action at the front end can also be performed with a double format. For this purpose trimming is performed with double benefit. The brochures are accordingly moved to a separating saw and then further guided to a three knife trimmer where the head and foot cuts are performed.

Advantageously, the method is integrated into a conventional three knife trimmer which, in addition to the front end trim, also performs head and foot trimming.

### BRIEF DESCRIPTION OF THE DRAWING

In the drawing:

FIG. 1 shows the device at the beginning of formation of the bulge in the flap;

FIG. 2 shows the device during the front end trimming action;

FIG. 3 shows a sectional view of a suction element; and

FIG. 4 is a plan view onto the support structure of a suction element.

### DESCRIPTION OF THE PREFERRED EMBODIMENTS

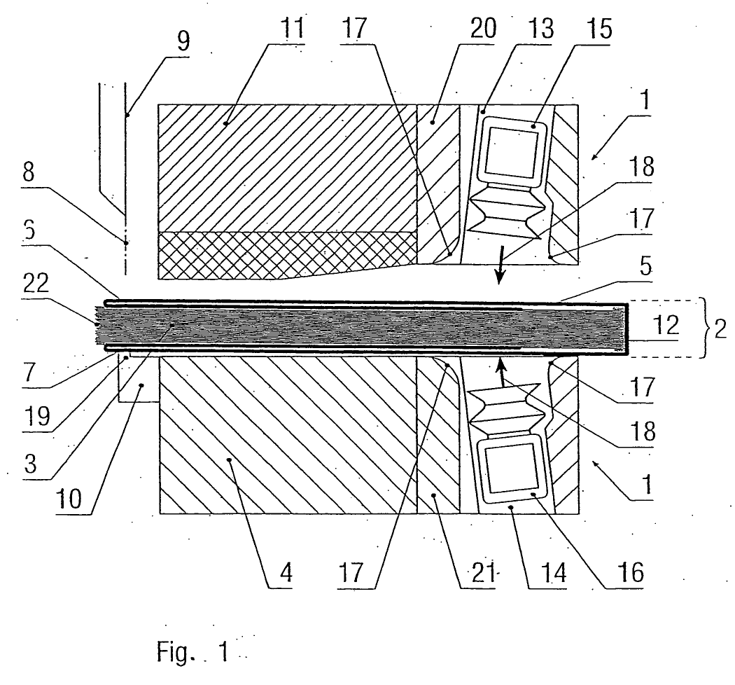

FIG. 1 shows schematically a section of a flap retraction device 1 to be used as a part of a standard three knife trimmer. The representation of FIG. 1 corresponds to the rest position. In this rest position the brochure 2 to be trimmed is positioned in its trimming position on the trimming table 4.

The brochure 2 is comprised of an inner book 3 which is cased in a cover 5. The cover 5 has a folded top flap 6 and a folded bottom flap 7 which enclose the inner book 3. The flaps 6 and 7 as well as the inner book 3 project past the trimming plane 8 indicated by the dash-dot line. On opposed sides of the flaps 6, 7, a knife 9 and a counter support 10 are positioned. Above the top flap 6 a vertically movable holding-down device 11 is provided. In the holding-down device 11 as well as in the trimming table 4, two recesses 13 and 14 are provided in the rearward area of the brochure 2 and extend parallel to the spine 12 of the book. An upper and a lower suction element 15, 16 are received therein, respectively. The recesses 13, 14 are limited laterally toward the flaps of the cover by rounded edges 17. The suction elements 15, 16 are movable relative to the trimming table 4 as well as to the holding-down device 11 in the direction of arrows 18. The movement is realized by piston-cylinder-units which are not shown in this schematic representation in order to simplify the drawing.

The suction elements 15, 16 can be embodied, for example, as bar-shaped suction elements whose longer dimension is positioned perpendicularly to the plane of the drawing. At its forward edge, which is positioned opposite the trimming plane 8, respectively, the knife 9, the counter support 10 has a projecting ledge 19 whose height corresponds approximately to the thickness of the bottom flap 7.

In the illustrated embodiment, the recesses 13, 14 with the suction elements 15, 16 are positioned in retrofittable receiving elements 20, 21 which have been retrofitted into the holding-down device 11 and the trimming table 4.

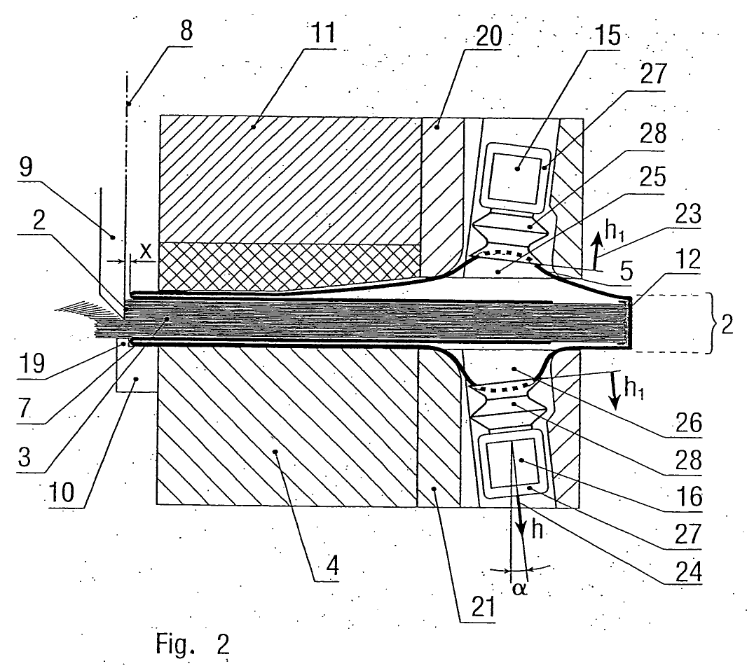

FIG. 2 shows the position of the parts represented in FIG. 1 during the trimming action at the front end 22. First, the suction elements 15, 16 are moved in the direction of arrow 17, 18 by the piston-cylinder-units (not shown) until they contact the flaps of the brochure. Subsequently, the suction elements are supplied with vacuum so that the flaps adhere to them by suction force. As soon as a sufficient holding force is developed, the suction elements 15, 16 are moved away from the inner book in the direction of arrows 23, 24. This movement takes place at an angle a relative to the normal on the inner book. This results in the formation of top and bottom bulges 25, 26 of the flaps 6, 7. Accordingly, the forward edges of the flaps are retracted away from the trimming plane 8 in the direction toward the spine 12 of the book. In this position, the holding-down device 11 is moved toward the trimming table 4 and clamps the inner book with the retracted flaps for the trimming action. The bottom flap 7 is positioned behind the ledge 19 of the counter support 10. In this position the connection of the suction elements 15, 16 with the vacuum source can be canceled so that forces are no longer exerted by the suction elements on the bulges formed in the flaps. In this position of the flaps, the trimming action carried out by the knife 9 along the trimming plane 8 takes place so that a straight front edge 22 of the brochure results. For possibly present tolerances, a safety spacing X prevents that the flaps could also be cut during trimming.

Upon completion of the trimming action, the holding-down device 11 is returned into its initial position. Now the flaps 6, 7 glide back into their initial position in the direction toward the front end 22 of the brochure by their own return forces. Depending on the adjustment of the stroke, the front edge of the flap can project past the front end 22 of the brochure. The thus trimmed brochure is then, for example, subsequently trimmed at the head and foot. After removal of the brochure from the trimming device, a new brochure can be positioned in the device for the trimming action.

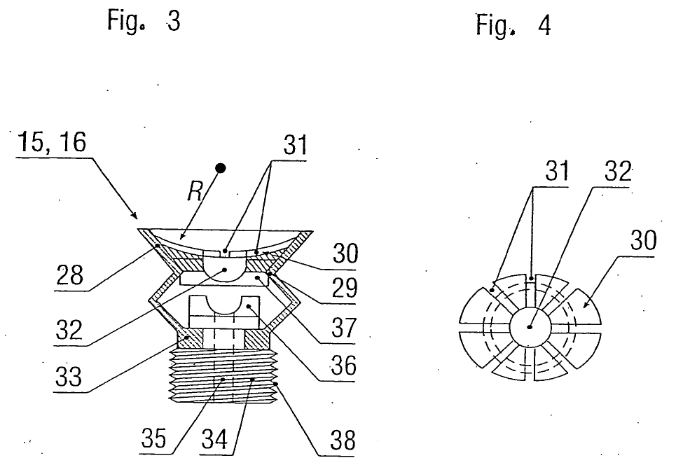

Even though the suction elements are formed as elongate suction bars, it is also possible to provide individual discrete suction elements, as shown in FIG. 3, which are threaded into a vacuum distribution pipe 27. The individual discrete suction elements 15, 16 are comprised of suction cups 28 which are formed as bellows. FIG. 3 shows an axial sectional view of the suction cup. Within the suction cup 28 a support structure 30 is clamped within the bellows 28 by the inner edge of the fold 29. The concave enveloping surface of the support structure oriented toward the flap corresponds to the portion of an imaginary cylindrical surface with the radius R. For distributing the vacuum, within the support structure depressions 31 are provided so that the suction forces can be distributed over the entire surface area of the support structure. These depressions 31 open into a central bore 32 which communicates in a switchable manner with a vacuum source. The lower edge of the suction cup 28 has an inwardly projecting bead 33 and engages a groove provided in a threadable fitting 34. The outer thread 38 of the fitting 34 is screwed into a corresponding threaded bore provided in the vacuum distribution pipe 27. In order for the suction cup 28 to be able to communicate with the vacuum of the vacuum distribution pipe 27, a further throughbore 35 is provided in the fitting 34 (not shown in a sectional view). At the upper end of the fitting 34 a guide member 36 is formed which is pointed like a wedge in the direction of the support structure 30. The edge of the wedge is positioned within the plane of the drawing. The support structure 30 comprises a corresponding wedge-shaped groove 37 which can be supported on the wedge of the guide member 36 when vacuum is applied. The guide member 36 and the support structure 30 are positioned at a spacing to one another under atmospheric conditions. When vacuum is present, the support structure 30 moves with the flap of the brochure against the spring force of the bellows 28 toward the fitting 34 until the support structure 30 is supported on the wedge of the guide member 36. In a direction perpendicular to the plane of the drawing, the position of the support structure 30 is thus fixed relative to the guide member 36. Transverse thereto, within the plane of the drawing, the support structure is however moveably supported. In this manner it is prevented that forces act on the flap of the cover. Several of the suction cups represented in FIG. 3 are arranged linearly in a row parallel to the spine 12 of the book/brochure. Depending on the dimensions of the book/brochure, different numbers of discrete suction cups can be used.

FIG. 4 shows a view onto the support structure 30. The depressions 31 extending radially from the central bore 32 can be seen in this illustration.

In this manner a device and a method are provided with which brochures with cased-in inner book can be trimmed in retrofitted standard machines such that the flaps project past the inner book after trimming.

While specific embodiments of the invention have been shown and described in detail to illustrate the inventive principles, it will be understood that the invention may be embodied otherwise without departing from such principles.

What is claimed is:

1. A trimming device having a trimming knife for trimming a brochure along a trimming plane at a front end of the brochure, wherein the brochure is comprised of a cover and an inner book cased in the cover with flaps of the cover being flush with or projecting past the inner book, wherein the brochure is clamped at a spine thereof on a trimming table, the trimming device comprising a set of movable suction elements for each one of the flaps configured to bulge the flaps and retract the flaps away from the trimming plane, respectively, wherein the movable suction elements are located, in a plan view onto the trimming table, for acting on the flaps between a holding-down device which extends essentially to the trimming plane and the spine of the brochure, and wherein the movable suction elements of each one of the sets are aligned along a straight line parallel to the spine of the brochure, respectively.

2. The trimming device according to claim 1, further comprising a drive configured to move the suction elements from a suction position into a holding position and move the suction elements from the holding position back into the suction position in a bidirectional movement direction, wherein the bidirectional movement direction is inclined relative to a normal on the flaps.

3. The trimming device according to claim 2, wherein the drive is a piston-cylinder-unit.

4. The trimming device according to claim 2, further comprising adjusting elements configured to adjust the suction position and the holding position of the suction elements.

5. The trimming device according to claim 2, wherein the suction element has a suction cup moveable in the bidirectional movement direction.

6. The trimming device according to claim 5, wherein the suction cup comprises a support structure configured to support the flap.

7. The trimming device according to claim 6, wherein the support structure has a concave enveloping surface.

8. The trimming device according to claim 7, wherein the enveloping surface is a portion of a cylinder surface.

9. The trimming device according to claim 4, wherein the suction cup is configured to be moveable in at least one direction perpendicularly to the bidirectional movement direction.

10. The trimming device according to claim 4, wherein at least one of the suction position and the holding position of each of the suction elements is adjustable independent of the suction position and the holding position of the other suction elements.

11. The trimming device according to claim 1, comprising a switchable vacuum source, wherein the suction element has a channel connected to the vacuum source.

12. The trimming device according to claim 11, wherein the channel has an adjustable throttle location configured to control a vacuum present at the suction element.

13. The trimming device according to claim 1, comprising means for synchronizing a movement of the suction elements to a trimming action performed by the trimming device.

14. The trimming device according to claim 1, comprising a trimming table having a ledge positioned in the trimming plane and facing the trimming knife, wherein the flap at the bottom of the brochure, when retracted, is positioned behind the ledge.

15. The trimming device according to claim 1, comprising a suction bar, wherein several of the suction elements are arranged on the suction bar.

16. A method for trimming a brochure along a trimming plane at a front end of the brochure, wherein the brochure is comprised of a cover and an inner book cased in the cover with flaps of the cover being flush with or projecting past the inner book, the method comprising the step of retracting the flap out of the trimming plane by generating a bulge of the flap before trimming.

17. The method according to claim 16, wherein the bulge of the flap is generated by applying a vacuum to the flap.

18. The method according to claim 17, further comprising the step of lowering a holding-down device onto the flap after generating the bulge to press the flap onto the inner book in the vicinity of the front end of the brochure until trimming is completed.

19. The method according to claim 18, wherein, after lowering the holding-down device and pressing the flap onto the inner book, the vacuum is cancelled.

20. The method according to claim 16, wherein trimming is performed with double benefit.

21. The method according to claim 16, wherein trimming is performed at the head, the foot, and the front end of the brochure.
